(19) United States
(12) Patent Application Publication
(10) Pub. No.: US 2018/0107802 A1
(43) Pub. Date: Apr. 19, 2018

(54) COMPUTER IMPLEMENTED METHOD AND SYSTEM, AND COMPUTER PROGRAM PRODUCT, FOR COLLECTING AND DISPLAYING HEALTH STATUS INFORMATION

(71) Applicant: SNEEZ, LLC, Winston-Salem, NC (US)

(72) Inventors: William Satterwhite, Winston-Salem, NC (US); Steve Hodges, Winston-Salem, NC (US)

(21) Appl. No.: 15/786,507

(22) Filed: Oct. 17, 2017

Related U.S. Application Data
(60) Provisional application No. 62/409,309, filed on Oct. 17, 2016.

(51) Int. Cl. G06F 19/00; H04W 4/08; G06Q 50/22

(52) U.S. Cl. CPC G06F 19/3493; G06F 19/36; G06Q 50/22; H04W 4/08; G06F 19/3418

(57) ABSTRACT

A computer implemented system and method, and a computer program product, for collecting and displaying crowd sourced health status information. For example, the method may include receiving and storing individual identification information for each of a plurality of individuals, and receiving and storing, for each of the plurality of identified individuals, group affiliation information in association with individual identification information. The method also may include receiving and storing health status information, which identifies a medical condition associated with an individual. The method also may include determining that at least another individual has the medical condition, and displaying information comprising a number of the individuals that have the medical condition.

### CROSS-REFERENCE TO RELATED APPLICATION

This application claims the benefit of U.S. Provisional Application No. 62/409,309, filed Oct. 17, 2016.

### FIELD

The present disclosure relates to a computer implemented system and method and apparatus, and a computer program product, for collecting and displaying health status information.

### SUMMARY

A computer implemented system and method, and a computer program product, for collecting and displaying crowd sourced health status information. For example, the method may include receiving individual identification information for each of a plurality of individuals, the individual identification information, comprising information identifying an individual, and storing, in a data store, the individual identification information. The method may also include, for each of the plurality of identified individuals, receiving group affiliation information, the group affiliation information comprising information identifying one or more groups with which each of the plurality of identified individuals are affiliated, and storing, in a data store, the group affiliation information in association with individual identification information. The method may further include receiving, for at least one of the plurality of the identified individuals, health status information, the health status information comprising information identifying at least one medical condition associated with the at least one of the plurality of identified individuals, wherein the medical condition is one of a medical symptom, a medical diagnosis, an illness, and a medical situation, and storing, in the data store, the received health status information in association with individual identification information for the one of the plurality of the identified individuals. The method also may include determining that at least another one of the plurality of identified individuals that are associated with the group with which the at least one of the plurality of identified individuals is associated has the at least one medical condition, and displaying information comprising a number of the plurality of identified individuals that have the at least one medical condition. The method may further include determining whether the number of the plurality of identified individuals having the at least one medical condition is greater than a predetermined threshold, and displaying information indicating that the number of the plurality of identified individuals having the at least one medical condition is, or is not, greater than the predetermined threshold. The one or more groups may be one of a predefined group and a user defined group. The one or more groups also may be based on an affiliation with an institution, such as, an educational institution. The method may also include, for each of the plurality of identified individuals, receiving subgroup affiliation information, the subgroup affiliation information comprising information identifying one or more subgroups with which each of the plurality of identified individuals are affiliated, and storing, in a data store, the sub group affiliation information in association with individual identification information. The one or more subgroups may be one of a grade level and a class of the educational institution. The one or more groups may be one of a predetermined location and a user determined location, such as a neighborhood, city, state, region, etc.

It will be appreciated that the above Summary is provided merely for purposes of summarizing some example embodiments so as to provide a basic understanding of some aspects of the disclosure. As such, it will be appreciated that the above described example embodiments are merely examples of some embodiments and should not be construed to narrow the scope or spirit of the disclosure in any way. It will be appreciated that the scope of the disclosure encompasses many potential embodiments, some of which will be further described below, in addition to those here summarized. Further, other aspects and advantages of embodiments disclosed herein will become apparent from the following detailed description taken in conjunction with the accompanying drawings which illustrate, by way of example, the principles of the described embodiments.

### BRIEF DESCRIPTION OF THE DRAWINGS

FIG. 1 is a block diagram illustrating an overview of an exemplary system for collecting and displaying crowd sourced health status information, according to an exemplary embodiment;

FIG. 2 is a schematic diagram of a mobile computing device, such as a smartphone, for collecting and displaying crowd sourced health status information, according to an exemplary embodiment.

FIG. 3 is a flow chart for a process for collecting and displaying crowd sourced health status information, according to an exemplary embodiment.

FIG. 4 is a screenshot of a mobile device executing an application for collecting and displaying crowd sourced health status information, wherein the application is displaying a Create Account interface for receiving user identification information, according to an exemplary embodiment.

FIG. 5 is a screenshot of a mobile device executing an application for collecting and displaying crowd sourced health status information, wherein the application is displaying an Add Child interface, according to an exemplary embodiment.

FIG. 6 is a screenshot of a mobile device executing an application for collecting and displaying crowd sourced health status information, wherein the application is displaying an Add Illness interface, according to an exemplary embodiment.

FIG. 7 is a screenshot of a mobile device executing an application for collecting and displaying crowd sourced health status information, wherein the application is displaying a My Children interface, according to an exemplary embodiment.

FIG. 8 is a screenshot of a mobile device executing an application for collecting and displaying crowd sourced health status information, wherein the application is displaying a Navigation interface, according to an exemplary embodiment.

FIG. 9 is a screenshot of a mobile device executing an application for collecting and displaying crowd sourced health status information, wherein the application is displaying a Dashboard, according to an exemplary embodiment.

FIG. 10 is a screenshot of a mobile device executing an application for collecting and displaying crowd sourced health status information, wherein the application is displaying a Log Sickness interface, according to an exemplary embodiment.

FIG. 11A and FIG. 11B are screenshots of a mobile device executing an application for collecting and displaying crowd sourced health status information, wherein the application is displaying an Outbreaks Map interface and an Outbreaks List interface, respectively, according to an exemplary embodiment.

FIG. 12 is a screenshot of a mobile device executing an application for collecting and displaying crowd sourced health status information, wherein the application is displaying an Alerts interface, according to an exemplary embodiment.

### DETAILED DESCRIPTION OF THE PREFERRED EMBODIMENTS

The present invention will now be described more fully hereinafter with reference to the accompanying drawings, in which a preferred embodiment of the invention is shown. This invention may, however, be embodied in many different forms and should not be construed as limited to the embodiments set forth herein; rather, this embodiment is provided so that this disclosure will be thorough and complete and will fully convey the scope of the invention to those skilled in the art. Like numbers refer to like elements throughout.

Exemplary embodiments may be implemented using a mobile application (an “app”) running on a portable computing device, e.g., a smartphone. Individual household illness data may be captured through crowd sourcing, and then aggregated into and displayed as actionable health status information. In an exemplary embodiment, in view of a breakout of a communicable disease, such as influenza, a family may use the health status information to decide whether to send a child to school.

In exemplary embodiments, the health status information can be aggregated in various ways. For example, health status information for a group of students could be aggregated at a class level, grade level, school level or school system level. In other examples, health status information can be aggregated at a healthcare enterprise level or at a business level. Health status information also can be aggregated at any number of geographical levels, e.g., municipality, state, country or other geographic region.

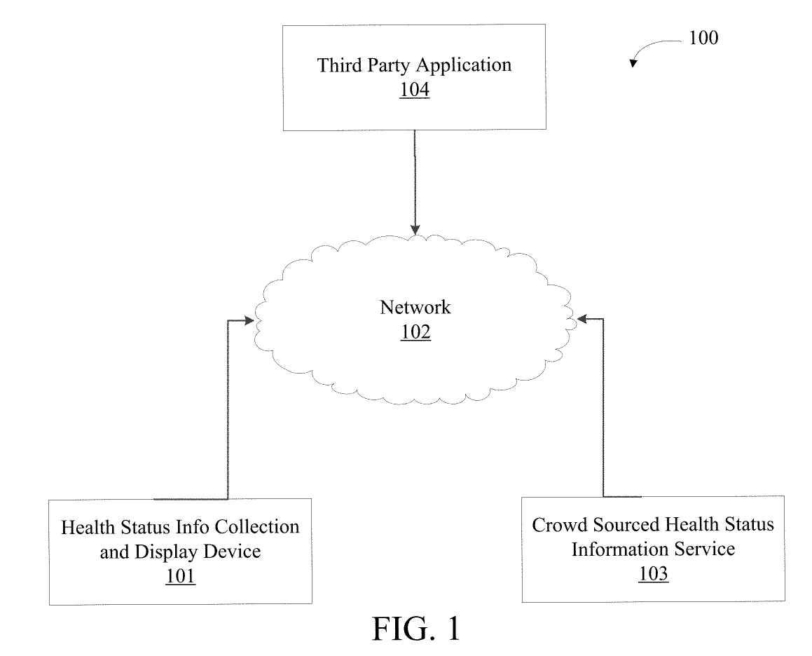

Reference is now made to FIG. 1, which illustrates an overview of a system for collecting and displaying crowd sourced health status information, in accordance with an exemplary embodiment. System 100 generally includes a health status information collection and display device 101, a network 102, and a crowd sourced health status information service 103. System 100 also may include one or more third party applications 104, which may communicate electronically with device 101 and/or the crowd sourced health status information service 103. For clarity, system 100 has been illustrated as including a single device for collecting and displaying crowd sourced health status information, a single network, a single crowd sourced information service and a single third party application. Such illustration is exemplary only, and it should be understood that any number of such components may be included in the systems and methods described herein.

Health status information collection and display device 101 may be in the form of one or more mobile or other electronic devices. In some embodiments, device 101 is a mobile device chosen from cell phones, mobile internet devices, personal digital assistants, smart phones, ultra-mobile PCs, netbooks, notebook computers, and combinations thereof. Device 101 may alternatively or additionally be in the form of one or more network (e.g., internet/cloud) servers, desktop computers, and combinations thereof. Without limitation, forecasting device 101 is preferably one or more network servers.

The health status information collection and display device 101 may communicate with crowd sourced health status information service 103. Crowd sourced health status information service 103 may include one or more processing, memory and storage devices. Such communication may be bi-directional, and may occur through a direct data connection (not shown), through network 102, or a combination thereof. Device 101 may similarly communicate with crowd source information service 103 and/or third party application 104, e.g., through a direct data connection, network 102, or a combination thereof.

Network 102 may be any network that carries data. Non-limiting examples of suitable networks that may be used as network 102 include the internet, private networks, virtual private networks (VPN), public switch telephone networks (PSTN), integrated services digital networks (ISDN), digital subscriber link networks (DSL), wireless data networks (e.g., cellular phone networks), other networks capable of carrying data, and combinations thereof. In some embodiments, network 102 is chosen from the internet, at least one wireless network, at least one cellular telephone network, and combinations thereof. Without limitation, network 102 is preferably the internet.

In some exemplary embodiments, the health status information collection and display device 101 and/or the crowd sourced health status information service 103 may interact with one or more third party applications 104 via network 102. For example, a business application may receive health status information and determine which products to market and where based on the received health status information. In another example, a business application of a healthcare facility and/or pharmacy may send information relating to the availability of flu vaccines responsive to receiving health status information. In another exemplary embodiment, a business application of a school or a school system may use the health status information to increase its pool of substitute teachers. In another example, a business application of any commercial enterprise may use the health status information to plan for heavy absenteeism, a pharmacy may use it to increase its inventory of flu related products, or a hospital or physician's office may use it to increase staffing levels.

In another exemplary embodiment, health status information comprised of a report of an illness could cause a business application to send a digital coupon to the reporting individual, or persons associated with the individual, e.g., a parent or spouse of the individual. In other exemplary embodiments, such a digital coupon could be sent by a business application to other individuals located near, or otherwise associated with, the reporting individual, e.g., all individuals in the same class or same zip code as the reporting individual.

In other exemplary embodiments, upon receiving health status information reporting a particular illness, a business application could send the information to interested manufacturers and/or retailers, who may engage in an auction, automatically or by choice, to bid on the right to distribute the digital coupon for goods or services for treating the reported illness.

In other exemplary embodiments, the application and/or system may be integrated with information systems associated with healthcare service providers. In such cases, the report of a symptom and/or symptoms may automatically cause the healthcare service provider's enterprise information system to send instructions to related users, e.g., users in the same grade and/or school on how to best prevent contracting the reported illness. In other exemplary embodiments, a healthcare service provider's information system may send a message inviting the reporting individual to schedule an appointment for further diagnosis and/or treatment. In other exemplary embodiments, the application and/or system may be configured to automatically notify a healthcare entity, such as a healthcare service provider, when the system or app receives information indicating that a patient/individual participating population health management project has experienced a particular symptom or illness.

In still other exemplary embodiments, the application and/or system may be integrated into a school system's information system. In response to receiving, health status information about a disease, the system could send, or cause a school system's information system to send, information about the school's policies related to a particular illness, e.g., “must be fever-free for 24 hours before returning to school,” etc. The information may be sent to individual user and/or a group of users with which the individual is associated, e.g., the individual's grade, school, etc.

Crowd sourced health status information service 103 may include a database capable of storing crowd sourced health status information. Such database may be stored and/or executed on one or more mobile or other electronic devices that may interface with device 101. Thus, crowd sourced health status information service 103 may be stored and/or executed on one or more co-located and/or geographically distributed servers. Alternatively or additionally, crowd source information database may be stored in memory within and/or accessible to device 101 (not shown). In some embodiments, crowd sourced information may be input into a crowd source health status information database by one or more users. Such inputs may be made through device 101 or another mobile or other electronic device.

Device 101 may aggregate or otherwise collect health status information. In some embodiments, device 101 may store aggregated health status information in memory (not shown). Such memory may be local to device 101, remote to device 101, or a combination thereof. Thus, while FIG. 1 depicts the health status information service 103 as being separate from device 101, it should be understood that device 101 may develop, store, and maintain its own collection/database of health status information. Device 101 may be able to access such “internal” sources of health status information more easily and/or rapidly than it can access external sources of such information.

As may be appreciated, the functionality and processing described herein may be performed by device 101 or by crowd sourced health status information service 103, or by a combination of the two. In addition, information stored by system 100 may be stored in device 101 or in a data store associated with crowd sourced health status information service 103, or by a combination of the two.

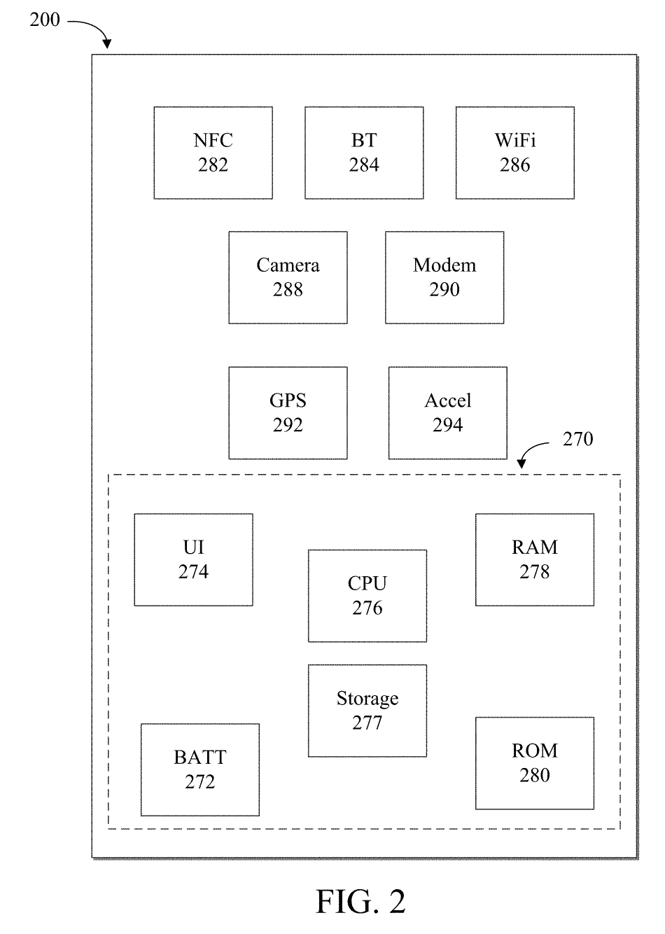

FIG. 2 is a schematic diagram of a mobile computing device 200, such as a smartphone, for executing an application for collecting and displaying crowd sourced health status information, according to an exemplary embodiment. Mobile device 200 typically comprises core hardware modules 270 central to the operation of the mobile device 200, such as a battery module 272, user interface module 274, a processor module 276, non-volatile storage 277, random access memory (RAM) 278, and read only memory (ROM) 280. Non-volatile storage 277 may comprise a hard drive or flash memory for storing the operating system, various applications and data, etc. Suitable mobile operating systems include iOS operating system, available from Apple, Inc. of Cupertino, Calif. and the Android operation system, available from Google, Inc. of Mountain View, Calif. The ROM 280 may include boot code that executes when the mobile device 200 is initially powered or reset, and may be separate from or included as part of the processor module 276. Initialization of the mobile device 200 as a medical device by modifying the booting process of the mobile device 200 is discussed further below. It should be noted that the processor module 276 may comprise any processing circuitry (e.g., a microprocessor or a microcontroller), may comprise more than one processing core, and may be spread among multiple interconnected hardware modules.

Mobile device 200 may also include other non-core hardware modules such as a near-field communication (NFC) module 282, a Bluetooth module 284, a WiFi module 286, a camera module 288, a cellular modem module 290, a GPS module 292, and an accelerometer module 294.

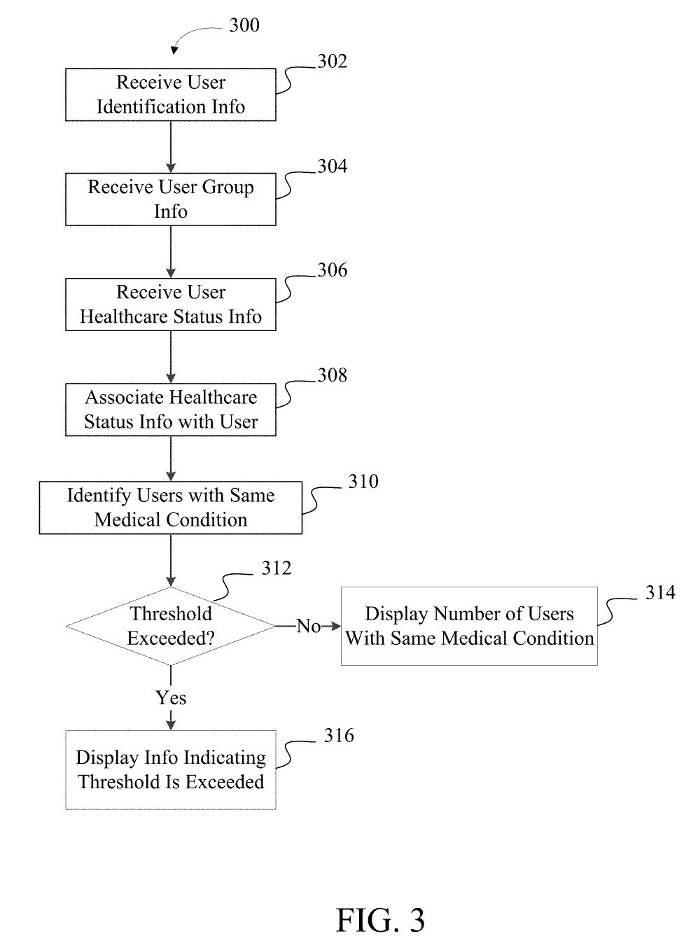

FIG. 3 is a flow chart for a process 300 for collecting and displaying crowd sourced health status information, according to an exemplary embodiment. For example, process 300 may be executed by an application (“app”) running on a mobile device, such as a smartphone or a smartwatch. Thus, the app may be downloaded from an online app store, and installed on a mobile device by a user. After the app is installed and launched, the process 300 illustrated in FIG. 3 may be executed by the app.

Continuing with FIG. 3, beginning with operation 302, process 300 may receive individual identification information for each of a plurality of individuals. The individual identification information may include information identifying an individual, and storing, in a data store, the individual identification information. In some exemplary embodiments, the identified individual may be a student attending an educational institution. Processing may continue with operation 304.

In operation 304, process 300 may receive, for each of the identified individuals, group affiliation information. The group affiliation information may be comprised of information identifying one or more groups with which each of the plurality of identified individuals are affiliated. In some exemplary embodiments, the group may be any predefined or user defined group. The group may be based on an affiliation with an institution, such as an educational institution. The individual also may be associated with one or more subgroups of the institution, such as a grade level or class, in the case of an educational institution. The group also may be based on a predetermined or user determined criteria, such as a location, a neighborhood, a city, a state, a region, etc. An individual may be associated with more than one group. For each of the identified individuals, process 300 also may store, in a data store, the group affiliation information in association with individual identification information. Processing may continue with operation 306.

In operation 306, process 300 may receive, for one of the plurality of the identified individuals, health status information. The health status information may include information indicating that an identified individual has one or more medical conditions, symptoms or diagnoses. In some exemplary embodiments, the medical condition may be selected from a predefined list of medical conditions. An exemplary list of medical conditions is set forth below:

TABLE 1
Medical Condition

vomiting
diarrhea
fever
common cold
virus/viral illness
ear infection
pinkeye
strep throat
impetigo
MRSA/staph skin
infection
lice
asthma exacerbation
hand, foot & mouth
flu (influenza virus)
roseola
ringworm
mono
croup
RSV
rotavirus
pertussis (whooping cough)
norovirus
chicken pox
fifth disease
scarlet fever
Zika virus
mumps
tuberculosis (TB)
stomach bug

Processing may continue with operation 308. In operation 308, process 300 may store the received health status information in association with individual identification information for the one of the plurality of the registered individuals. Processing may continue with operation 310.

In operation 310, process 300 may determine one or more identified individuals that are associated with the group with which the one of the plurality of identified individuals is associated and that have a medical condition that is the same as the one of the plurality of identified individuals. Process 300 also may display information about the number of such individuals. Processing may continue with operation 312.

In operation 312, process 300 may determine whether the number of the identified one or more registered individuals is greater than a predetermined threshold. If the number of the identified one or more registered individuals is not greater than a predetermined threshold, processing may continue with operation 314.

In operation 314, process 300, may display information indicating the number of the identified one or more registered individuals that have a medical condition that is the same as the one of the plurality of identified individuals.

Returning to operation 312, if the number of the identified one or more registered individuals is greater than a predetermined threshold, processing may continue with operation 316. In operation 316, process 300 may display information indicating that the number of the identified one or more registered individuals is greater than the predetermined threshold, in addition to displaying information indicating the number of registered individuals that have a medical condition that is the same as the one of the plurality of identified individuals.

In some exemplary embodiments, process 300 may display information indicating that a predefined threshold has been exceeded by displaying the number representing other users having the same medical condition in different colors. Table 2 below, sets forth exemplary thresholds and how to display information about the number of users having the same medical condition in a color coded format:

TABLE 2

| | | | | Whole School-colors | | |
|---|---|---|---|---|---|---|
| | | | | (# of students in all | | |
| | Grade-colors | | | grades combined reporting | | |
| Medical | (# of students) | | | this medical condition) | | |
| Condition | Green | Yellow | Red | Green | Yellow | Red |
| vomiting | 0 | 1 to 2 | 3 and up | 0-2 | 3 to 10 | >10 |
| diarrhea | 0 | 1 to 2 | 3 and up | 0-2 | 3 to 10 | >10 |
| fever | 0 | 1 to 2 | 3 and up | 0-2 | 3 to 10 | >10 |
| common cold | 0 | 1 to 2 | 3 and up | 0-2 | 3 to 20 | >20 |
| virus/viral | 0 | 1 to 2 | 3 and up | 0-2 | 3 to 20 | >20 |
| illness | | | | | | |
| ear infection | 0 | 1 to 2 | 3 and up | 0-2 | 3 to 20 | >20 |
| pinkeye | 0 | 1 to 2 | 3 and up | 0-2 | 3 to 20 | >20 |
| strep throat | 0 | 1 | 2 and up | 0-2 | 3 to 20 | >20 |
| impetigo | 0 | 1 to 2 | 3 and up | 0-2 | 3 to 20 | >20 |
| MRSA/staph skin | 0 | 1 | 2 and up | 0-2 | 3 to 20 | >20 |
| infection | | | | | | |
| lice | 0 | 1 | 2 and up | 0-2 | 3 to 10 | >10 |
| asthma | 0 | 1 to 2 | 3 and up | 0-2 | 3 to 20 | >20 |
| exacerbation | | | | | | |
| hand, foot & | 0 | 1 | 2 and up | 0-2 | 3 to 10 | >10 |
| mouth | | | | | | |
| flu (influenza | 0 | 1 | 2 and up | 0-2 | 3 to 10 | >10 |
| virus) | | | | | | |
| roseola | 0 | 1 | 2 and up | 0-2 | 3 to 20 | >20 |
| ringworm | 0 | 1 to 2 | 3 and up | 0-2 | 3 to 20 | >20 |
| mono | 0 | 1 | 2 and up | 0-2 | 3 to 20 | >20 |
| croup | 0 | 1 | 2 and up | 0-2 | 3 to 20 | >20 |
| RSV | 0 | 1 | 2 and up | 0-2 | 3 to 10 | >10 |
| rotavirus | 0 | 1 | 2 and up | 0-2 | 3 to 10 | >10 |
| pertussis | 0 | 1 | 2 and up | 0-2 | 3 to 5 | >5 |
| (whooping cough) | | | | | | |
| norovirus | 0 | 1 | 2 and up | 0-2 | 3 to 10 | >10 |
| chicken pox | 0 | 1 | 2 and up | 0-2 | 3 to 5 | >5 |
| fifth disease | 0 | 1 | 2 and up | 0-2 | 3 to 20 | >20 |
| scarlet fever | 0 | 1 | 2 and up | 0-2 | 3 to 20 | >20 |
| Zika virus | 0 | 1 | 2 and up | 0-2 | 3 to 20 | >20 |
| mumps | 0 | 1 | 2 and up | 0-2 | 3 to 20 | >20 |
| tuberculosis (TB) | 0 | 1 | 2 and up | 0-2 | 3 to 20 | >20 |
| stomach bug | 0 | 1 | 2 and up | 0-2 | 3 to 10 | >10 |
| All Conditions | | | | 0 | 1 to 5 | >5 |

In other embodiments, school wide cumulative thresholds may be established. For example, if no medical conditions have been reported,

As may be appreciated, the present invention is not necessarily limited to the exemplary sequence of operations illustrated in FIG. 3.

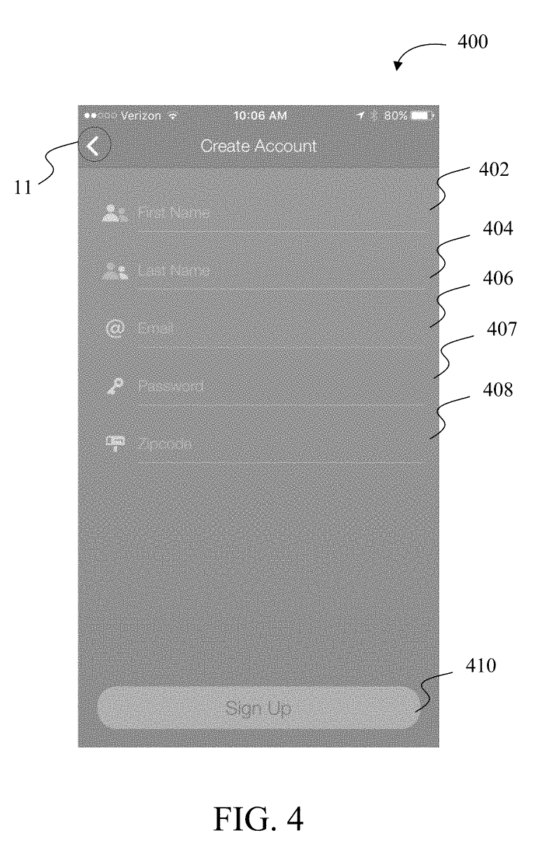

In some exemplary embodiments, device 101 may be implemented by an app running on a mobile computing device, as illustrated in FIG. 2. Thus, the app may be downloaded from an online app store, and installed on a mobile device by a user. Screenshots for an interface to an exemplary app are illustrated in FIGS. 4-12, and may be used to collect and display crowd sourced health status information for an educational institution, such as, an elementary school. The embodiments illustrated in FIGS. 4-12 and discussed below are, however, exemplary and the invention is not limited to collecting and displaying crowd sourced health status information related to school. Rather, collecting and displaying crowd sourced health status information for any enterprise, educational, governmental, commercial, etc., is within the scope of the invention.

After the app is installed and launched for the first time, an initial Sign In screen may be displayed, whereby the app may receive an email address and password from an existing user. A new user may select a Sign Up button, which may cause the app to display a Create Account interface 400, as illustrated in FIG. 4. As shown in FIG. 4, Create Account interface 400 may be used to receive the following user information: first name 402, last name 404, email address 406, password 407 and zip code 408. Other user information may also be received by the Create Account interface 400. A Sign Up button 410 can be used to submit the user information to the app and to the crowd sourced health status information service 103. A back button 11 may be provided, which can be used to return to a previous screen or a home screen. After receiving the user information, the app may request permission from the user to allow location services and/or to allow push notifications.

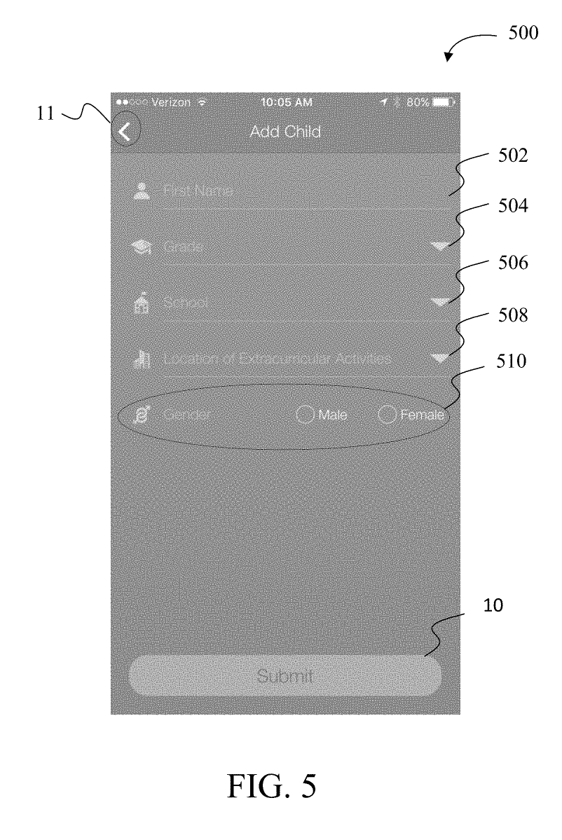

After device 101 receives user information for a new user, it may display an Add Child interface 500, which is illustrated in FIG. 5. A registered user may add information about one or more children via interface 500. Information about an existing child also may be edited via interface 500. As shown by FIG. 5, interface 500 may be used to receive the following information about a child: first name 502, grade 504, school 506, location of extracurricular activities 508 and gender 510. A submit button 10 can be used to submit the child information to the app and to the crowd sourced health status information service 103. A back button 11 may be used to return to the previous or a home screen. A skip button (not shown) may be provided so that a user can skip the process of adding information about a child.

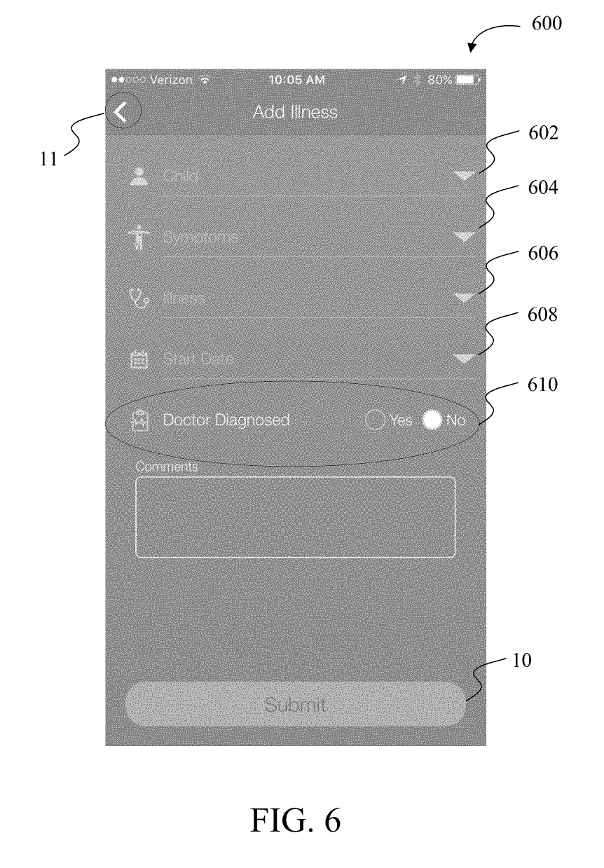

After receiving child information, device 101 may display an Add Illness interface 600, which is illustrated in FIG. 6. A registered user may use interface 600 to add information about one or more illnesses for each child that has been added via interface 500. Information about an illness also may be edited via interface 600. As shown by FIG. 6, interface 600 may be used to receive information on the following information about an illness: child 602, one or more symptoms 604, one or more illnesses 606, start date 608 and if doctor diagnosed 610. A submit button 10 can be used to submit the illness information to the app and to the crowd sourced health status information service 103. A back button 11 can be used to return to a previous screen or a home screen. A skip button (not shown) may be provided so that a user can skip the process of adding information about an illness.

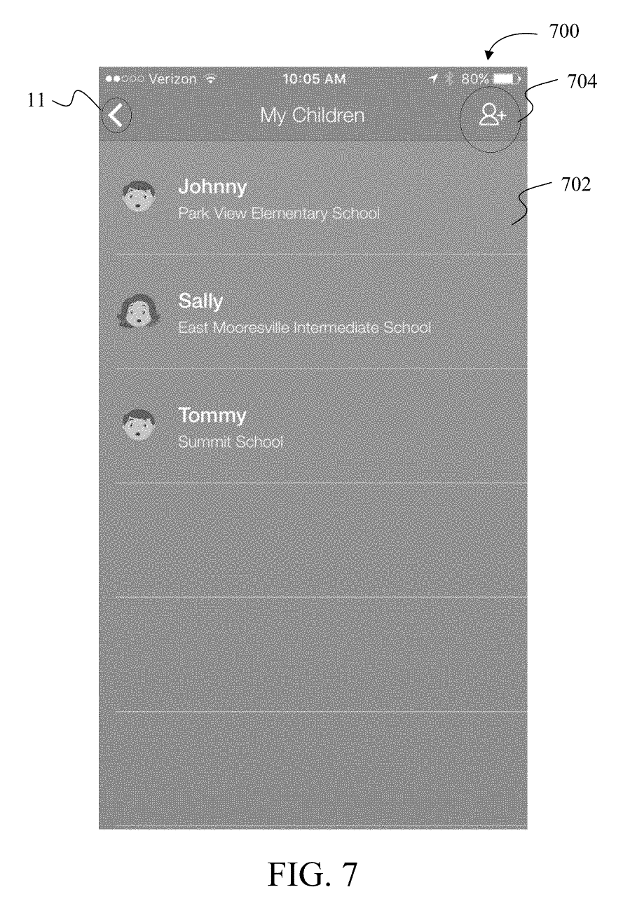

After submitting information about an illness via the Add Illness interface 600, or skipping that step, in some exemplary embodiments, the app may display a My Children interface 700, which is illustrated in FIG. 7. In addition, after an email address and password are received from an existing user, the My Children interface 700 may be displayed.

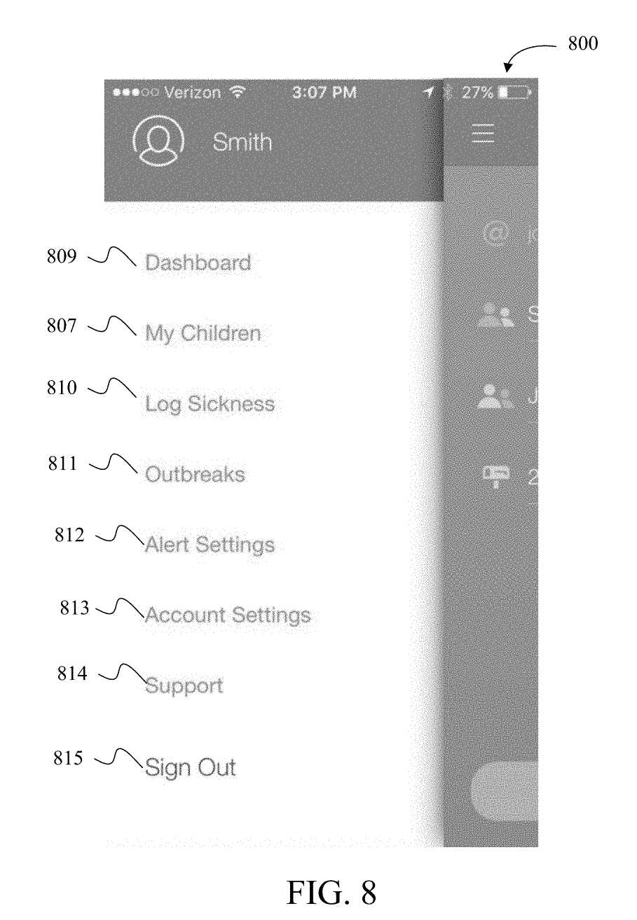

As can be seen from FIG. 7, the My Children interface 700 displays information about children 702 that have been added by and, therefore, are associated with, the user. If the Add Child button 704 is selected, the Add Child interface 500 may be displayed. If the main menu or back button 11 is selected, a navigation interface 800 is displayed, which is illustrated in FIG. 8. A user can use the navigation interface 800 to navigate to any of the interfaces discussed herein.

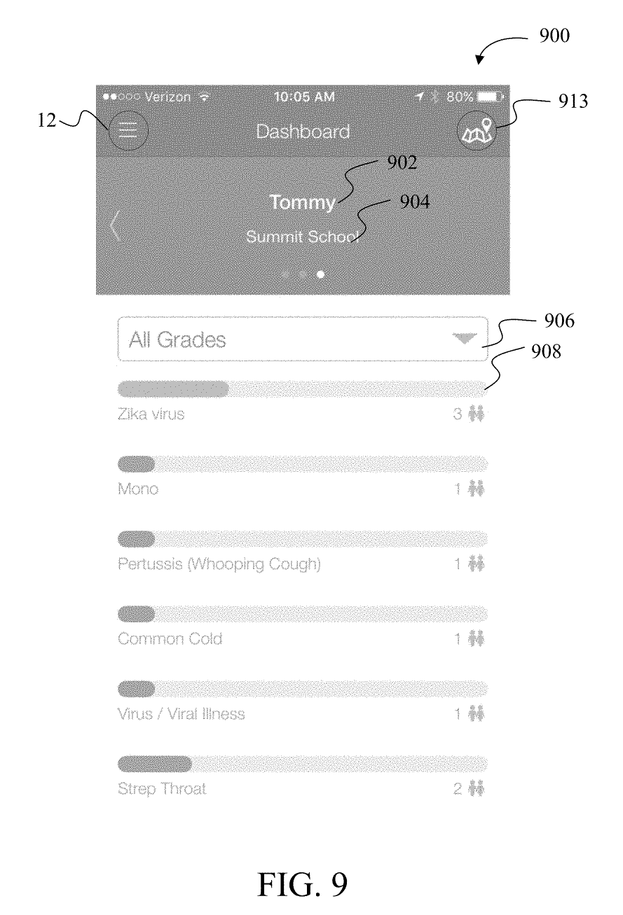

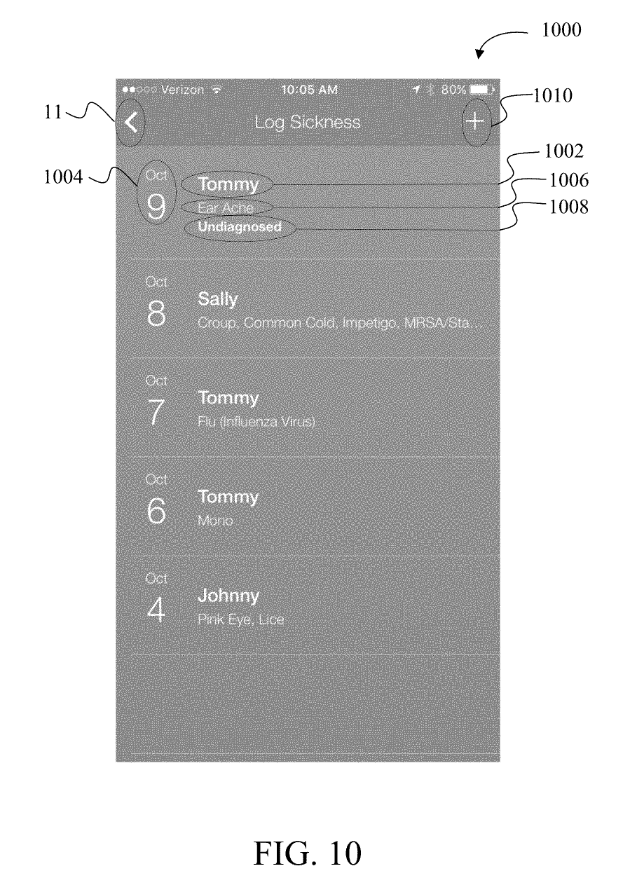

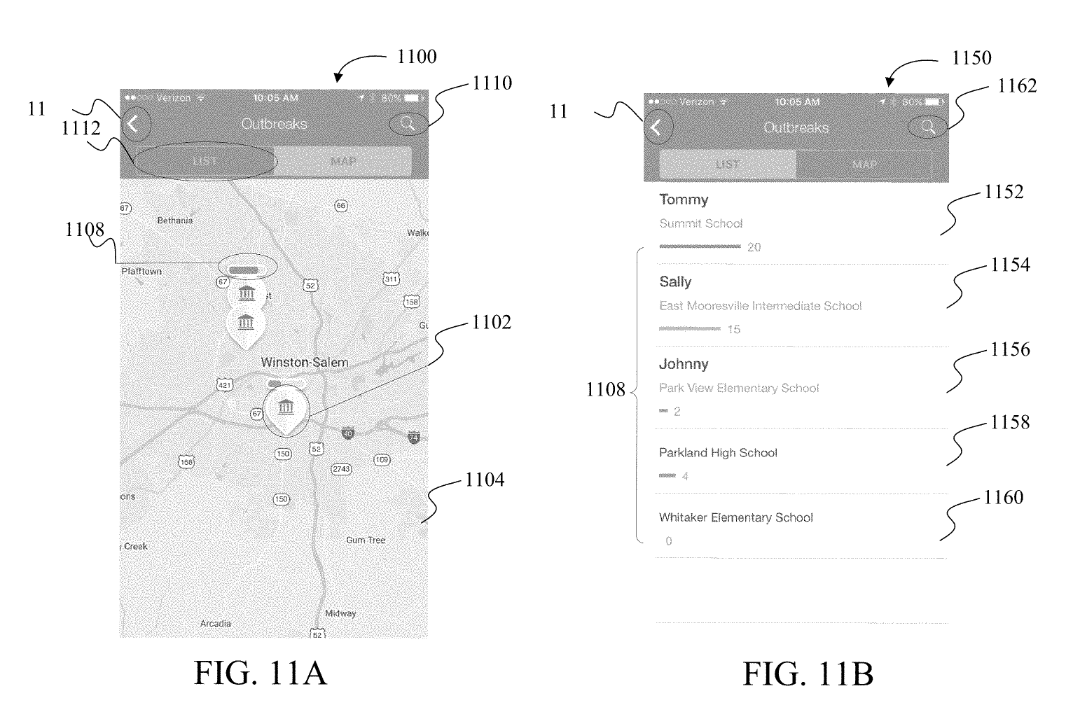

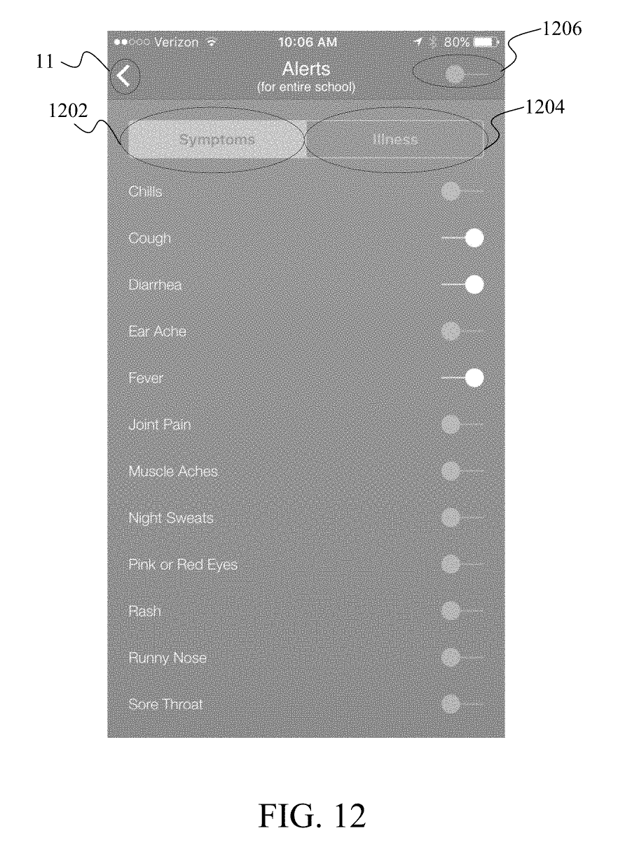

As shown in FIG. 8, navigation interface 800 can be used to navigate to any of the interfaces discussed herein. For example, if the Dashboard button 809 is selected, a Dashboard interface 900, which is illustrated in FIG. 9, may be displayed. Similarly, if the My Children button 807 is selected, a My Children interface 700 may be displayed; if a Log Sickness button 810 is selected, a Log Sickness interface 1000, which is illustrated in FIG. 10, may be displayed; if an Outbreaks button 811 is selected, an Outbreaks interface 1100, which is illustrated in FIG. 11 is displayed; if an Alert Settings button 812 is selected, an Alert Settings interface 1200, which is illustrated in FIG. 12 is displayed; if an Account Settings button 813 is selected, an Account Settings interface is displayed; if a Support button 814 is selected, a Support interface may be displayed; and if a Sign Out button 815 is selected, a user will be signed out of the app.

When a child 702 is selected via the My Children interface 700, a Dashboard 900, which is illustrated in FIG. 9, is displayed for the selected child. As shown in FIG. 9, Dashboard 900 displays crowd sourced health status information for the selected child 902. The Dashboard also displays aggregated crowd sourced health status information about a school 904 attended by the selected child 902. As shown in FIG. 9, grade selector 906 can be used to select one or all grades for which crowd sourced health status information is to be displayed. Dashboard 900 also may display information about specific symptoms and/or illnesses for a child's school, including information about the number of children reporting a symptom and/or illness.

In some exemplary embodiments, Dashboard 900 also may display information about a number of children reporting a symptom and/or illness in a bar graph format 908, as illustrated in FIG. 9. In other exemplary embodiments, a bar graph 908 representing a number of reported symptoms and/or illnesses may be displayed in varying colors, as described above with respect to Table 2.

Dashboard 900 also may include an Add Illness button, which, when selected, would display the Add Illness interface 600, and an Edit Profile button (not shown), which, when selected, would display a Child Details interface (not shown). A user may edit, via the Child Details button, the child information entered via the Add Child interface 500. Dashboard 900 also may include an Outbreak button 913, which, when selected, would display an Outbreaks interface 1100.

Returning to the navigation interface 800 illustrated in FIG. 8, if a user selects the Log Sickness button 810, the Log Sickness interface 1000, which is illustrated in FIG. 10, is displayed. As shown by FIG. 10, the Log Sickness interface 1000 displays information entered by a user about children's illnesses. The Log Sickness interface 1000 shows, for example, information identifying the child 1002, the date of the illness 1004, the illnesses and/or symptoms 1006 and whether the illnesses and/or symptoms were diagnosed by a medical professional 1008. The Log Sickness interface 1000 also may include an Add Illness button 1010, which, when selected, displays the Add Illness interface 600. The Log Sickness interface 1000 also may include a back button or main menu button 11.

Returning to navigation interface 800, if an Outbreaks button 811 is selected, either Outbreak Map interface 1100 or Outbreak List interface 1150, which are illustrated in FIGS. 11A and 11B, is displayed. As shown in FIG. 11A, Outbreaks Map interface 1100 displays crowd sourced health status information superimposed on a map of a geographic area associated with a user. The geographic area may be determined using the location services of device 101 or it may be determined by other location information such as the school, zip code or extracurricular activity location information associated with a child. The Outbreaks Map interface also may display an icon 1102 representing a school, including a child's school, at which an outbreak of a symptom or disease has occurred. In some exemplary embodiments, an outbreak occurs where the number of reported cases of a symptom and/or illness exceeds a predetermined threshold. The predetermined threshold may be established by a user on a symptom by symptom or illness by illness basis via the Alerts interface 1200, which is illustrated in FIG. 12. Predetermined thresholds also may be set at a grade, school, zip code or other geographic levels.

Continuing with Outbreak Map interface 1100, if icon 1102 is selected, information identifying the name of the school represented by icon 1102 is displayed in area 1104. Interface 1100 also may include an area in which the number of medical symptoms and/or illnesses reported at the identified school is displayed. The information about the number of medical symptoms and/or illnesses reported at the identified school also may be displayed as a color coded bar graph.

The Outbreaks Map interface 1100 also may include a back button or main menu button 11 and a Search button 1110. Selecting the Search button 1110 causes a Search interface to be displayed, by which a user can search for a particular school. Outbreak Maps interface 1100 also includes a List button 1112, which, when selected, causes an Outbreak List interface 1150 to be displayed.

As shown in FIG. 11B, the Outbreaks List interface 1150 displays crowd sourced health status information in a list form. Each of the list entries 1152, 1154 and 1156 include identifying a child and the child's school, and the number of reported symptoms and/or illnesses at the child's school. The Outbreak List interface also may include one or more list entries 1158, 1160, which identify other schools in the same geographic region as one or more of the children's schools and information about the reported number of illnesses and/or symptoms at each school. As shown, in FIG. 11B, the information about the reported number of illnesses may be displayed either numerically, or in a color coded bar chart. The Outbreaks List interface 1150 also may include a back button or main menu button 11 and a Search button 1162.

In some exemplary embodiments, notification of information about an outbreak, or the reporting of an individual health status update, can be pushed to a user via an electronic communication, such as a voice message, email, text message, etc. Information about an outbreak also may be accessed by a user via the Outbreaks Maps interface 1100 or the Outbreaks List interface 1150.

In other exemplar embodiments, locations other than a child's school, such as the location of extracurricular activities, may be associated with a child. In such embodiments, a user may be notified of an outbreak of a medical condition at the location of a child's extracurricular activity, via an Outbreak interface and/or an electronic communication.

Returning to the navigation interface 800, if an Alerts Settings button 812 is selected, an Alerts interface 1200, which is illustrated in FIG. 12, is displayed. As shown in FIG. 12, Alerts interface 1200 has a Symptoms button 1202 and an Illness button 1204. When Symptoms button 1202 is selected, a list of symptoms is displayed and when the Illness button 1204 is selected a list of illnesses is displayed. Beside each listed illness or symptom is a slider, which can be used to turn on or off an alert for the corresponding symptom or illness. In this example, if the slider is pushed to the right, the alert is turned on, and if the slider is pushed to the left, the alert is turned off. Alerts interface 1200 also may include an All button 1206, which can be used to turn on or turn off all of the alerts for all of the listed symptoms or illnesses. Finally, Alerts interface 1200 also may include a back button and/or a main menu button 11.

Returning to the navigation interface 800, if an Account Settings button 813 is selected, an Accounts Settings interface is displayed. The Accounts Settings interface allows a user to edit the information entered via the Create Account interface 400, which is illustrated in FIG. 4.

Embodiments described herein may be practiced with various computer system configurations including, mobile devices, hand-held devices, tablets, microprocessor systems, microprocessor-based or programmable consumer electronics, personal computers, laptop computers, minicomputers, mainframe computers and the like. Some embodiments may also be practiced in distributed computing environments where tasks are performed by remote processing devices that are linked through one or more networks, such as one or more wireline networks and/or one or more wireless networks.

A computer program product may be used to implement an application for collecting and displaying crowd sourced health status information, in some example embodiments. A computer program product embodiment may include a machine-readable, non-transitory (non-volatile) storage medium (media) having instructions stored thereon/in, which can be used to program a computer to perform any of the processes of the embodiments described herein. Computer code for operating and configuring a scoring system is preferably downloaded and stored in non-volatile memory, although the entire program code, or portions thereof, may also be stored in any other volatile or non-volatile memory medium or device as is well known, such as a read only memory (ROM) or random access memory (RAM), or provided on any media capable of storing program code, such as any type of rotating or solid state media, or any type of media or device suitable for storing instructions and/or data. Additionally, the entire program code, or portions thereof, may be transmitted and downloaded from a software source over a transmission medium, e.g., over the Internet or wirelessly, or from another server, or transmitted over any other conventional network connection as is well known (e.g. extranet, virtual private network (VPN), local area network (LAN), etc.) using any communication medium and protocols (e.g. transmission control protocol/internet protocol (TCP/IP), hypertext transport protocol (HTTP), HTTP secure (HTTPS), Ethernet, etc.). It may be appreciated that computer code for implementing embodiments of the present invention can be implemented in any programming language that can be executed on a client system and/or server or server system such as, for example, Swift, C, Objective-C, C++, hypertext markup language (HTML), any other markup language, Java™, JavaScript, ActiveX, any other scripting language, such as VBScript, and many other programming languages may be used. As may be appreciated, a software development platform, such as, the XCode platform, which is available from Apple, Inc., may be used to develop the computer code for the application for collecting and displaying crowd sourced health status information, which is described above.

Many modifications and other embodiments of the inventions set forth herein will come to mind to one skilled in the art to which these disclosed embodiments pertain having the benefit of the teachings presented in the foregoing descriptions and the associated drawings. Therefore, it is to be understood that embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure. In this regard, for example, different combinations of elements and/or functions than those explicitly described above are also contemplated within the scope of the disclosure. Although specific terms are employed herein, they are used in a generic and descriptive sense only and not for purposes of limitation.

It should be understood that although the terms first, second, etc. may be used herein to describe various steps or calculations, these steps or calculations should not be limited by these terms. These terms are only used to distinguish one operation or calculation from another. For example, a first calculation may be termed a second calculation, and, similarly, a second step may be termed a first step, without departing from the scope of this disclosure. As used herein, the term “and/or” and the “/” symbol includes any and all combinations of one or more of the associated listed items.

As used herein, the singular forms “a,” “an” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

What is claimed is:

1. A computer implemented method for collecting and displaying crowd sourced health status information, the method comprising:
receiving individual identification information for each of a plurality of individuals, the individual identification information, comprising information identifying an individual;
storing, in a data store, the individual identification information;
for each of the plurality of identified individuals, receiving group affiliation information, the group affiliation information comprising information identifying one or more groups with which each of the plurality of identified individuals are affiliated;
storing, in a data store, the group affiliation information in association with individual identification information;
receiving, for at least one of the plurality of the identified individuals, health status information, the health status information comprising information identifying at least one medical condition associated with the at least one of the plurality of identified individuals, wherein the medical condition is one of a medical symptom, a medical diagnosis, an illness, and a medical situation;
storing, in the data store, the received health status information in association with individual identification information for the one of the plurality of the identified individuals;
determining that at least another one of the plurality of identified individuals that are associated with the group with which the at least one of the plurality of identified individuals is associated has the at least one medical condition; and
displaying information comprising a number of the plurality of identified individuals that have the at least one medical condition.

2. The method of claim 1, further comprising:
determining whether the number of the plurality of identified individuals having the at least one medical condition is greater than a predetermined threshold; and
displaying information indicating that the number of the plurality of identified individuals having the at least one medical condition is greater than the predetermined threshold.

3. The method of claim 1, further comprising:
determining whether the number of the plurality of identified individuals having the at least one medical condition not is greater than a predetermined threshold; and
displaying information indicating that the number of the plurality of identified individuals having the at least one medical condition is not greater than the predetermined threshold.

4. The method of claim 1, wherein the one or more groups is one of a predefined group and a user defined group.

5. The method of claim 1, wherein the one or more groups is based on an affiliation with an educational institution.

6. The method of claim 5, further comprising:
for each of the plurality of identified individuals, receiving subgroup affiliation information, the subgroup affiliation information comprising information identifying one or more subgroups with which each of the plurality of identified individuals are affiliated; and
storing, in a data store, the sub group affiliation information in association with individual identification information.

7. The method of claim 6, wherein the one or more subgroups are one of a grade level and a class of the educational institution.

8. The method of claim 1, wherein the one or more groups is one of a predetermined location and a user determined location.

9. A computer implemented system for collecting and displaying crowd sourced health status information, the system comprising:
at least one processor; and
at least one memory storing computer program code, wherein the at least one memory and stored computer program code are configured, with the at least one processor, to cause the system to at least:
receive individual identification information for each of a plurality of individuals, the individual identification information, comprising information identifying an individual;
store, in a data store, the individual identification information;
for each of the plurality of identified individuals, receive group affiliation information, the group affiliation information comprising information identifying one or more groups with which each of the plurality of identified individuals are affiliated;
store, in a data store, the group affiliation information in association with individual identification information;
receive, for at least one of the plurality of the identified individuals, health status information, the health status information comprising information identifying at least one medical condition associated with the at least one of the plurality of identified individuals, wherein the medical condition is one of a medical symptom, a medical diagnosis, an illness, and a medical situation;
store, in the data store, the received health status information in association with individual identification information for the one of the plurality of the identified individuals;
determine that at least another one of the plurality of identified individuals that are associated with the group with which the at least one of the plurality of identified individuals is associated has the at least one medical condition; and
display information comprising a number of the plurality of identified individuals that have the at least one medical condition.

10. The system of claim 9, wherein the at least one memory and the stored computer program code are configured, with the at least one processor, to further cause the system to at least:
determine whether the number of the plurality of identified individuals having the at least one medical condition is greater than a predetermined threshold; and
display information indicating that the number of the plurality of identified individuals having the at least one medical condition is greater than the predetermined threshold.

11. The system of claim 9, wherein the at least one memory and stored computer program code are configured, with the at least one processor, to further cause the system to at least:
determine whether the number of the plurality of identified individuals having the at least one medical condition not is greater than a predetermined threshold; and
display information indicating that the number of the plurality of identified individuals having the at least one medical condition is not greater than the predetermined threshold.

12. The system of claim 9, wherein the one or more groups is one of a predefined group and a user defined group.

13. The system of claim 9, wherein the one or more groups is based on an affiliation with an educational institution.

14. The system of claim 13, wherein the at least one memory and stored computer program code are configured, with the at least one processor, to further cause the system to at least:
for each of the plurality of identified individuals, receive subgroup affiliation information, the subgroup affiliation information comprising information identifying one or more subgroups with which each of the plurality of identified individuals are affiliated; and
store, in a data store, the sub group affiliation information in association with individual identification information.

15. The system of claim 14, wherein the one or more subgroups are one of a grade level and a class of the educational institution.

16. The system of claim 9, wherein the one or more groups is one of a predetermined location and a user determined location.

17. A computer program product for collecting and displaying crowd sourced health status information, the computer program product comprising at least one non-transitory computer-readable storage medium having program instructions stored thereon, which when executed by at least one processor, causes the at least one processor to perform a method comprising:
receiving individual identification information for each of a plurality of individuals, the individual identification information, comprising information identifying an individual;
storing, in a data store, the individual identification information;
for each of the plurality of identified individuals, receiving group affiliation information, the group affiliation information comprising information identifying one or more groups with which each of the plurality of identified individuals are affiliated;
storing, in a data store, the group affiliation information in association with individual identification information;
receiving, for at least one of the plurality of the identified individuals, health status information, the health status information comprising information identifying at least one medical condition associated with the at least one of the plurality of identified individuals, wherein the medical condition is one of a medical symptom, a medical diagnosis, an illness, and a medical situation;
storing, in the data store, the received health status information in association with individual identification information for the one of the plurality of the identified individuals;
determining that at least another one of the plurality of identified individuals that are associated with the group with which the at least one of the plurality of identified individuals is associated has the at least one medical condition; and
displaying information comprising a number of the plurality of identified individuals that have the at least one medical condition.

18. The computer program product of claim 17, wherein the at least one non-transitory computer-readable storage medium having program instructions stored thereon, which when executed by the at least one processor, causes the at least one processor to perform a method further comprising:
determining whether the number of the plurality of identified individuals having the at least one medical condition is greater than a predetermined threshold; and
displaying information indicating that the number of the plurality of identified individuals having the at least one medical condition is greater than the predetermined threshold.

19. The computer program product of claim 17, wherein the at least one non-transitory computer-readable storage medium having program instructions stored thereon, which when executed by the at least one processor, causes the at least one processor to perform a method further comprising:
determining whether the number of the plurality of identified individuals having the at least one medical condition not is greater than a predetermined threshold; and
displaying information indicating that the number of the plurality of identified individuals having the at least one medical condition is not greater than the predetermined threshold.

20. The computer program product of claim 18, wherein the one or more groups is one of a predefined group and a user defined group.

21. The computer program product of claim 18, wherein the one or more groups is based on an affiliation with an educational institution.

22. The computer program product of claim 21, wherein the at least one non-transitory computer-readable storage medium having program instructions stored thereon, which when executed by the at least one processor, causes the at least one processor to perform a method further comprising:
for each of the plurality of identified individuals, receiving subgroup affiliation information, the subgroup affiliation information comprising information identifying one or more subgroups with which each of the plurality of identified individuals are affiliated; and
storing, in a data store, the sub group affiliation information in association with individual identification information.

23. The computer program product of claim 22, wherein the one or more subgroups are one of a grade level and a class of the educational institution.

24. The computer program product of claim 18, wherein the one or more groups is one of a predetermined location and a user determined location.
